(19) United States
(12) Patent Application Publication
(10) Pub. No.: US 2024/0287271 A1
(43) Pub. Date: Aug. 29, 2024

(54) DOUBLE-COATED RADIATION CURING PVC PRE-COATING MATERIAL AND PREPARATION METHOD THEREOF

(71) Applicant: BANFERT NEW MATERIALS CO., LTD., Changsha (CN)

(72) Inventors: Xinxiong LI, Changsha (CN); Dongming ZHANG, Changsha (CN)

(21) Appl. No.: 17/791,917

(22) PCT Filed: Jun. 8, 2021
(86) PCT No.: PCT/CN2021/098790

§ 371 Date: May 10, 2024

(30) Foreign Application Priority Data
May 14, 2021 (CN) 202110529938.2

(51) Int. Cl. C08J 7/04; C09D 4/06; C09D 7/63; C09D 127/06; C09D 135/02

(52) U.S. Cl. CPC C08J 7/042; C09D 4/06; C09D 7/63; C09D 127/06; C09D 135/02; C08J 2327/06; C08J 2335/02

(57) ABSTRACT

This invention provides a double-coated radiation curing PVC pre-coating material, which includes the PVC transparent film and the radiation curing coating from bottom to top, and the radiation curing coating includes the elastic attached base coat and the top coat from bottom to top.

### TECHNICAL FIELD

This invention belongs to the pre-coating material field and relates a double-coated radiation curing PVC pre-coating material and its preparation method.

### BACKGROUND

The multi-coated radiation curing pre-coating of existing technologies consists of PVC transparent film and radiation curing coating from bottom to top, and the radiation curing coating consists of attached base coat, elastic base coat, functional layer and top coat (a total of 4 radiation curing coatings) from bottom to top.

### SUMMARY

To solve the above problem, this invention provides a double-coated radiation curing PVC pre-coating material, which comprises PVC transparent film and radiation curing coating from bottom to top, and the radiation curing coating comprises elastic attached base coat and top coat from bottom to top.

Preferably, a functional layer is set between the elastic attached base coat and the top coat.

Preferably, the elastic attached base coat contains 20-50% bifunctional urethane acrylate, 20-40% reactive diluent and 1-3% initiator.

Preferably, the top coat contains 10-20% bifunctional urethane acrylate, 30-50% hexa-functional urethane acrylate, 10-30% reactive diluent, 3-15% hard filler and 0.5-2% initiator.

Preferably, the bifunctional urethane acrylate is prepared through the reaction between isocyanate and macromolecular dihydric alcohol, chain extension using micromolecular dihydric alcohol and end capping using hydroxyl-containing acrylate monomer.

Preferably, the macromolecular dihydric alcohol is selected from one or many of PCL polyols, neopentyl glycol adipate and polycarbonate diols.

Preferably, the reactive diluent is prepared through the reaction between epoxy diluent containing long chain segment and acrylate monomer under the action of catalyst.

Preferably, the epoxy diluent containing long chain segment is selected from one or many of anacardiol glycidyl ether, decyl glycidyl ether, alkyl (C12) glycidyl ether, butyl glycidyl ether, poly (propylene glycol) diglycidyl ether and neopentyl glycol diglycidyl ether.

Preferably, the acrylate monomer is selected from one or many of methacrylate, ethyl acrylate, 2-methyl methacrylate and 2-ethyl methacrylate.

This invention also provides a preparation method for the double-coated radiation curing PVC pre-coating material, applying the elastic attached base coat onto the PVC transparent film, curing it using LED lamp, applying the functional layer and the top coat successively and curing it using excimer lamp.

This invention also provides products containing the double-coated radiation curing PVC pre-coating material.

Compared to existing technologies, this invention has the following advantages and beneficial effects:

This invention provides a preparation method for bifunctional urethane acrylate, with excellent tenacity and elongation up to 50%, which can ensure the tenacity between the elastic attached base coat and the PVC transparent layer. The reactive diluent prepared through the formula in this invention has excellent permeability to the PVC transparent layer and it can ensure the adhesion between the elastic attached base coat and the PVC transparent layer. With low Tg (glass transition temperature) and good tenacity, the reactive diluent can improve the film flexibility. When used cooperatively with the high-tenacity bifunctional urethane acrylate, it can ensure the application of subsequent PVC pre-coating and can be used to prepare SPC floor (Stone Plastic Composites), without whitening and cracking in the host pressing process. Without need for extinction powder, the material of the top coat in this invention can achieve the polishing effect to improve coating performance.

This invention discloses the double-coated radiation curing PVC pre-coating material, which comprises the PVC transparent film and the radiation curing coating from bottom to top, and the radiation curing coating comprises the elastic attached base coat and the top coat from bottom to top (a total of 2 layers). In this invention, the elastic attached base coat and the top coat are prepared through the specific formula of bifunctional urethane acrylate and reactive diluent, which make up the radiation curing coating, simplifies the elastic base coat, the functional base coat and the top coat of existing technologies and achieves the effect with need for two layers only. Meanwhile, a functional layer can be set as needed. This invention can simplify process, reduce material and equipment input, save production site and improve PVC pre-coating performance.

### DETAILED DESCRIPTION OF THE EMBODIMENTS

Content of this invention can be further interpreted combined with a detailed description of the preferred implementation method and the examples contained below: Unless otherwise specified, all technologies and scientific terminologies used hereunder have the same meanings that ordinary technical personnel of the field in this application generally understand. In case of discrepancies between the definitions of specific terminologies disclosed in existing technologies and any definitions provided in this application, the latter shall prevail.

This invention provides a double-coated radiation curing PVC pre-coating material, which comprises the PVC transparent film and the radiation curing coating from bottom to top, and the radiation curing coating comprises the elastic attached base coat and the top coat from bottom to top.

In a preferred implementation mode, a functional layer is set between the elastic attached base coat and the top coat.

In a preferred implementation mode, the elastic attached base coat contains 20-50% bifunctional urethane acrylate, 20-40% reactive diluent and 1-3% initiator.

In a preferred implementation mode, the top coat contains 10-20% bifunctional urethane acrylate, 30-50% hexa-functional urethane acrylate, 10-30% reactive diluent, 3-15% hard filler and 0.5-2% initiator.

In a preferred implementation mode, the bifunctional urethane acrylate is prepared through the reaction between isocyanate and macromolecular dihydric alcohol, chain extension using micromolecular dihydric alcohol and end capping using hydroxyl-containing acrylate monomer.

In a preferred implementation mode, the macromolecular dihydric alcohol is selected from one or many of PCL polyols, neopentyl glycol adipate and polycarbonate diols.

In a preferred implementation mode, the molecular weight of PCL polyols is 1000-3000, that of neopentyl glycol adipate is 2000-4000 and that of polycarbonate diols is 2000-4000.

In a preferred implementation mode, the isocyanate is selected from one or many of isophorone diisocyanate, 1,4-dicyclohexylmethane diisocyanate and hexamethylene diisocyanate.

In a preferred implementation mode, the micromolecular dihydric alcohol is selected from one or many of Isophorone diisocyanate, 1,4-butanediol, 1,4-cyclohexanedimethanol and hydroxyethyl bisphenol A.

In a preferred implementation mode, the hydroxyl-containing acrylate monomer is selected from one or many of hydroxyethyl acrylate, hydroxyethyl methylacrylate and butyl acrylate.

In a preferred implementation mode, the weight ratio of macromolecular dihydric alcohol, isocyanate, micromolecular dihydric alcohol and hydroxyl-containing acrylate monomer is 1:2-6:1:0.5-0.8.

In this invention, the bifunctional urethane acrylate is prepared through the reaction between macromolecular dihydric alcohol and isocyanate, micromolecular dihydric alcohol and hydroxyl-containing acrylate monomer. The chain extender is added so that the elongation of the bifunctional urethane acrylate can reach 50% and the activity of end group is eliminated using hydroxyl-containing acrylate monomer to vanish its functional group and obtain the bifunctional urethane acrylate with specific performance.

In a preferred implementation mode, the reactive diluent is prepared through the reaction between epoxy diluent containing long chain segment and acrylate monomer under the action of catalyst.

In a preferred implementation mode, the epoxy diluent containing long chain segment is selected from one or many of anacardiol glycidyl ether, decyl glycidyl ether, alkyl (C12) glycidyl ether, butyl glycidyl ether, poly (propylene glycol) diglycidyl ether and neopentyl glycol diglycidyl ether.

In a preferred implementation mode, the acrylate monomer is selected from one or many of methacrylate, ethyl acrylate, 2-methyl methacrylate and 2-ethyl methacrylate.

In a preferred implementation mode, the catalyst is selected from one or many of triethylamine, Titanium tetraisopropanolate and triphenylphosphine.

In a preferred implementation mode, the molar ratio of epoxy diluent containing long chain segment, acrylate monomer and catalyst is 1:1:0.2-0.6.

The reactive diluent prepared in this invention has excellent permeability to the PVC transparent layer and it can ensure the adhesion between the elastic attached base coat and the PVC transparent layer and improve the film flexibility. The inventor supposes that the specific functional group of raw materials increases the reactivity and the cross-linked structure of the cured film to form a highly cross-linked network.

This invention also provides a preparation method for the double-coated radiation curing PVC pre-coating material, applying the elastic attached base coat onto the PVC transparent film, curing it using LED lamp, applying the functional layer and the top coat successively and curing it using excimer lamp.

This invention also provides products containing the double-coated radiation curing PVC pre-coating material. e.g.: The double-coated radiation curing PVC pre-coating material has been applied to products formed by wood surface, paper surface and plastics surface, and so on.

Raw materials of this invention are purchased from the following manufacturers:
Hexa-functional urethane acrylate: Youyang Technology T7280
Bifunctional urethane acrylate: Youyang Technology T7210
Reactive diluent: Trimethylolpropane triacrylate, Guangzhou Sanwang
Initiator: Diphenyl (2,4,6-trimethylbenzoyl) phosphine oxide, Aladin
Hard filler: BASF ASP101
PCL polyols: Merck Sigma-Aldrich, 189405
Neopentyl glycol adipate: Merck Sigma-Aldrich, 192805
Isophorone diisocyanate: Merck Sigma-Aldrich, 317624
Hydroxyethyl acrylate: Henghu Chemical
Anacardiol glycidyl ether: Runfeng

### Example 1

This example provides a double-coated radiation curing PVC pre-coating material, which comprises the PVC transparent film and the radiation curing coating from bottom to top. The radiation curing coating comprises the elastic attached base coat and the top coat from bottom to top.

The elastic attached base coat contains 35% bifunctional urethane acrylate, 25% reactive diluent and 2% initiator and it is prepared through directly mixing the above materials.

The top coat contains 15% bifunctional urethane acrylate, 40% hexa-functional urethane acrylate, 25% reactive diluent, 10% hard filler and 1% initiator.

Preparation method for the bifunctional urethane acrylate: After PCL polyols (molecular weight: 1000), neopentyl glycol adipate (molecular weight: 2000) and polycarbonate diols react with Isophorone diisocyanate at 80° C. for 2 h, add 1,4-butanediol to react for 1 h and add hydroxyethyl acrylate to react at 65° C. for 2 h. The molar ratio of PCL polyols, neopentyl glycol adipate, Isophorone diisocyanate, 1,4-butanediol and hydroxyethyl acrylate is 0.5:0.5:5:1:0.7.

Preparation method for the reactive diluent: As per part by weight, 20% anacardiol glycidyl ether and 30% methacrylate react at 95° C. for 2 h under the action of triethylamine. The molar ratio of anacardiol glycidyl ether, methacrylate and triethylamine is 1:1:0.4.

Preparation method for the double-coated radiation curing PVC pre-coating material: Apply the elastic attached base coat onto the PVC transparent film, cure it using LED lamp, apply the elastic attached base coat onto the top coat and cure it using 172 nm excimer lamp to obtain the double-coated radiation curing PVC pre-coating material.

### Example 2

This example provides a double-coated radiation curing PVC pre-coating material, which comprises the PVC transparent film and the radiation curing coating from bottom to top, and the radiation curing coating comprises the elastic attached base coat and the top coat from bottom to top.
The elastic attached base coat contains 10% bifunctional urethane acrylate, 25% reactive diluent and 2% initiator and it is prepared through directly mixing the above materials.

The top coat contains 15% bifunctional urethane acrylate, 40% hexa-functional urethane acrylate, 25% reactive diluent, 10% hard filler and 1% initiator.

Preparation method for the bifunctional urethane acrylate: After PCL polyols (molecular weight: 1000), neopentyl glycol adipate (molecular weight: 2000) and polycarbonate diols react with Isophorone diisocyanate at 80° C. for 2 h, add 1,4-butanediol to react for 1 h and add hydroxyethyl acrylate to react at 65° C. for 2 h. The molar ratio of PCL polyols, neopentyl glycol adipate, Isophorone diisocyanate, 1,4-butanediol and hydroxyethyl acrylate is 0.5:0.5:5:1:0.7.

Preparation method for the reactive diluent: As per part by weight, 20% anacardiol glycidyl ether and 30% methacrylate react at 95° C. for 2 h under the action of triethylamine. The molar ratio of anacardiol glycidyl ether, methacrylate and triethylamine is 1:1:0.4.

Preparation method for the double-coated radiation curing PVC pre-coating material: Apply the elastic attached base coat onto the PVC transparent film, cure it using LED lamp, apply the elastic attached base coat onto the top coat and cure it using 172 nm excimer lamp to obtain the double-coated radiation curing PVC pre-coating material.

### Example 3

This example provides a double-coated radiation curing PVC pre-coating material, which comprises the PVC transparent film and the radiation curing coating from bottom to top, and the radiation curing coating comprises the elastic attached base coat and the top coat from bottom to top.

The elastic attached base coat contains 35% bifunctional urethane acrylate, 25% reactive diluent and 2% initiator and it is prepared through directly mixing the above materials.

The top coat contains 20% bifunctional urethane acrylate, 20% hexa-functional urethane acrylate, 25% reactive diluent, 10% hard filler and 10% initiator.

Preparation method for the bifunctional urethane acrylate: After PCL polyols (molecular weight: 1000), neopentyl glycol adipate (molecular weight: 2000) and polycarbonate diols react with Isophorone diisocyanate at 80° C. for 2 h, add 1,4-butanediol to react for 1 h and add hydroxyethyl acrylate to react at 65° C. for 2 h. The molar ratio of PCL polyols, neopentyl glycol adipate, Isophorone diisocyanate, 1,4-butanediol and hydroxyethyl acrylate is 0.5:0.5:5:1:0.7.

Preparation method for the reactive diluent: As per part by weight, 20% anacardiol glycidyl ether and 30% methacrylate react at 95° C. for 2 h under the action of triethylamine. The molar ratio of anacardiol glycidyl ether, methacrylate and triethylamine is 1:1:0.4.

Preparation method for the double-coated radiation curing PVC pre-coating material: Apply the elastic attached base coat onto the PVC transparent film, cure it using LED lamp, apply the elastic attached base coat onto the top coat and cure it using 172 nm excimer lamp to obtain the double-coated radiation curing PVC pre-coating material.

### Example 4

This example provides a double-coated radiation curing PVC pre-coating material, which comprises the PVC transparent film and the radiation curing coating from bottom to top, and the radiation curing coating comprises the elastic attached base coat and the top coat from bottom to top.

The elastic attached base coat contains 35% bifunctional urethane acrylate (marketable), 25% reactive diluent and 2% initiator and it is prepared through directly mixing the above materials.

The top coat contains 15% bifunctional urethane acrylate (marketable), 40% hexa-functional urethane acrylate, 25% reactive diluent, 10% hard filler and 1% initiator.

Preparation method for the reactive diluent: As per part by weight, 20% anacardiol glycidyl ether and 30% methacrylate react at 95° C. for 2 h under the action of triethylamine. The molar ratio of anacardiol glycidyl ether, methacrylate and triethylamine is 1:1:0.4.

Preparation method for the double-coated radiation curing PVC pre-coating material: Apply the elastic attached base coat onto the PVC transparent film, cure it using LED lamp, apply the elastic attached base coat onto the top coat and cure it using 172 nm excimer lamp to obtain the double-coated radiation curing PVC pre-coating material.

### Example 5

This example provides a double-coated radiation curing PVC pre-coating material, which comprises the PVC transparent film and the radiation curing coating from bottom to top, and the radiation curing coating comprises the elastic attached base coat and the top coat from bottom to top.

The elastic attached base coat contains 35% bifunctional urethane acrylate, 25% reactive diluent (trimethylolpropane triacrylate) and 2% initiator and it is prepared through directly mixing the above materials.

The top coat contains 15% bifunctional urethane acrylate, 40% hexa-functional urethane acrylate, 25% reactive diluent (trimethylolpropane triacrylate), 10% hard filler and 1% initiator.

Preparation method for the bifunctional urethane acrylate: After PCL polyols (molecular weight: 1000), neopentyl glycol adipate (molecular weight: 2000) and polycarbonate diols react with Isophorone diisocyanate at 80° C. for 2 h, add 1,4-butanediol to react for 1 h and add hydroxyethyl acrylate to react at 65° C. for 2 h. The molar ratio of PCL polyols, neopentyl glycol adipate, Isophorone diisocyanate, 1,4-butanediol and hydroxyethyl acrylate is 0.5:0.5:5:1:0.7.

Preparation method for the double-coated radiation curing PVC pre-coating material: Apply the elastic attached base coat onto the PVC transparent film, cure it using LED lamp, apply the elastic attached base coat onto the top coat and cure it using 172 nm excimer lamp to obtain the double-coated radiation curing PVC pre-coating material.

### Example 6

This example provides a double-coated radiation curing PVC pre-coating material, which comprises the PVC transparent film and the radiation curing coating from bottom to top, and the radiation curing coating comprises the elastic attached base coat and the top coat from bottom to top.

The elastic attached base coat contains 35% bifunctional urethane acrylate, 25% reactive diluent and 2% initiator and it is prepared through directly mixing the above materials.

The top coat contains 15% bifunctional urethane acrylate, 40% hexa-functional urethane acrylate, 25% reactive diluent, 10% hard filler and 1% initiator.

Preparation method for the bifunctional urethane acrylate: After PCL polyols (molecular weight: 1000), neopentyl glycol adipate (molecular weight: 2000) and polycarbonate diols react with Isophorone diisocyanate at 80° C. for 2 h, add 1,4-butanediol to react for 1 h and add hydroxyethyl acrylate to react at 65° C. for 2 h. The molar ratio of PCL polyols, neopentyl glycol adipate, Isophorone diisocyanate, 1,4-butanediol and hydroxyethyl acrylate is 0.5:0.5:5:1:0.7.

Preparation method for the reactive diluent: As per part by weight, 20% anacardiol glycidyl ether and 30% methacrylate react at 95° C. for 2 h under the action of triethylamine. The molar ratio of anacardiol glycidyl ether, methacrylate and triethylamine is 1:1:0.4.

Preparation method for the double-coated radiation curing PVC pre-coating material: Apply the elastic attached base coat onto the PVC transparent film, cure it using LED lamp, apply the elastic attached base coat onto the top coat and cure it using 172 nm excimer lamp to obtain the double-coated radiation curing PVC pre-coating material.

### Performance Test

Through reference to ASTM D3359, test the adhesion of materials of examples 1-6 and the results are shown in Table 1;

Through reference to ISO 1518, test the scratch resistance of materials of examples 1-6 and the results are shown in Table 1;

Cleaning performance test: Place the materials obtained from examples 1, 4 and 5 under room temperature, apply a 1-2 N force onto the coating surface using ZEBRA mark pen with an angle with the coating surface of about 90°, draw 5 5-10 mm lines at constant speed and wipe the surface using dust-free cloth after 2 min. The test result shows that 5 lines in example 1 can be easily removed and 5 lines in examples 4 and 5 are obvious and cannot be removed.

Through reference to GB 4085-2005, test heating warpage of materials of examples 1-6 and the results are shown in Table 1.

TABLE 1
Performance test result

| | | Scratch | Heating |
|---|---|---|---|
| | | resistance/ | warpage/ |
| Item | Adhesion | kg | mm |
| Example 1 | 5B | 3.5 | 0.04 |
| Example 2 | 5B | 3.4 | 0.05 |
| Example 3 | 4B | 3.0 | 1.2 |
| Example 4 | 3B | 2.8 | 1.0 |
| Example 5 | 3B | 2.5 | 1.3 |
| Example 6 | 4B | 2.7 | 1.6 |

The above examples just illustrate the principle and effect of this invention, but they do not pose restrictions on this invention. Anybody familiar with this technology is allowed to modify or alter the above examples without violating the spirit and scope of this invention. Thus, all equivalent modifications or alterations made by people with common knowledge of the technical field without violating the spirit and technical thinking of this invention shall still be included in the claims hereunder.

1. A double-coated radiation curing PVC pre-coating material, which comprises a PVC transparent film and a radiation curing coating from bottom to top, and the radiation curing coating comprises the elastic attached base coat and the top coat from bottom to top.

2. The double-coated radiation curing PVC pre-coating material of claim 1, wherein a functional layer is set between the elastic attached base coat and the top coat.

3. The double-coated radiation curing PVC pre-coating material of claim 1, wherein the elastic attached base coat comprises 20-50% bifunctional urethane acrylate, 20-40% reactive diluent and 1-3% initiator.

4. The double-coated radiation curing PVC pre-coating material of claim 1, wherein the top coat comprises 10-20% bifunctional urethane acrylate, 30-50% hexa-functional urethane acrylate, 10-30% reactive diluent, 3-15% hard filler and 0.5-2% initiator.

5. The double-coated radiation curing PVC pre-coating material of claim 3, wherein the bifunctional urethane acrylate is prepared through the reaction between isocyanate and macromolecular dihydric alcohol, chain extension using micromolecular dihydric alcohol and end capping using hydroxyl-containing acrylate monomer: preferably the macromolecular dihydric alcohol is selected from one or many of PCL polyols, neopentyl glycol adipate and polycarbonate diols.

6. The double-coated radiation curing PVC pre-coating material of claim 3, wherein the reactive diluent is prepared through the reaction between epoxy diluent containing long chain segment and acrylate monomer under the action of catalyst.

7. The double-coated radiation curing PVC pre-coating material of claim 6, wherein the epoxy diluent containing long chain segment is selected from one or many of anacardiol glycidyl ether, decyl glycidyl ether, alkyl (C12) glycidyl ether, butyl glycidyl ether, poly (propylene glycol) diglycidyl ether and neopentyl glycol diglycidyl ether.

8. The double-coated radiation curing PVC pre-coating material of claim 7, wherein the acrylate monomer is selected from one or many of methacrylate, ethyl acrylate, 2-methyl methacrylate and 2-ethyl methacrylate.

9. The preparation method for the double-coated radiation curing PVC pre-coating material of claim 1, comprising: applying the elastic attached base coat onto the PVC transparent film, curing it using LED lamp, applying the functional layer and the top coat successively and curing it using excimer lamp.

10. The product comprising the double-coated radiation curing PVC pre-coating material of claim 1.
